(19) United States
(12) Patent Application Publication
(10) Pub. No.: US 2015/0029134 A1
(43) Pub. Date: Jan. 29, 2015

(54) DRIVING AND SENSING METHOD FOR SINGLE-LAYER MUTUAL CAPACITIVE MULTI-TOUCH SCREEN

(71) Applicant: NOVATEK Microelectronics Corp., Hsin-Chu (TW)

(72) Inventors: PENG LIU, ShenZhen (CN); Chih-Chang Lai, Taichung City (TW)

(73) Assignee: NOVATEK Microelectronics Corp., Hsin-Chu (TW)

(21) Appl. No.: 14/058,280

(22) Filed: Oct. 20, 2013

(30) Foreign Application Priority Data
Jul. 24, 2013 (CN) 201310312490.4

(51) Int. Cl. G06F 3/044

(52) U.S. Cl. CPC G06F 3/044
USPC 345/174

(57) ABSTRACT

A driving and sensing method for a single-layer mutual capacitive multi-touch screen includes inputting a first driving signal to a plurality of touch sensing electrodes along a first direction and receiving a first sensing signal corresponding to the first driving signal along the first direction; and inputting a second driving signal to the plurality of touch sensing electrodes along a second direction and receiving a second sensing signal corresponding to the second driving signal along the second direction; wherein the second direction is substantially perpendicular to the first direction. The plurality of touch sensing electrodes are disposed in the single-layer mutual capacitive multi-touch screen, and each of the plurality of touch sensing electrodes includes at least one driving area and at least one receiving area, wherein all driving areas and receiving areas are located in a same layer of the single-layer mutual capacitive multi-touch screen.

### BACKGROUND OF THE INVENTION

1. Field of the Invention

The present invention relates to a driving and sensing method for a single-layer mutual capacitive multi-touch screen, and more particularly, to a driving and sensing method having the benefits of self capacitive touch sensing technology and mutual capacitive touch sensing technology.

2. Description of the Prior Art

In recent years, touch sensing technology has advanced at such a pace that many consumer electronic products including mobile phones, GPS navigation systems, tablets, personal digital assistants (PDA) and laptops are equipped with touch sensing functions. In many of these electronic products, the touch sensing functions are included in a display area whose original use was only for display functions. In other words, the original display panels have been replaced by touch screens capable of both display and touch sensing functions. The touch screen can generally be divided into out-cell, in-cell and on-cell touch screens according to the difference in structure therein. The out-cell touch screen is composed of an independent touch screen and a general display panel. In the in-cell touch screen, a touch sensing device is directly disposed inside a substrate in the display panel, and in the on-cell touch screen, the touch sensing device is directly disposed outside the substrate in the display panel.

Touch sensing technology can be classified into a resistive type, a capacitive type and an optical type. The capacitive type touch screens have become more popular over time as they have many advantages such as high sensing accuracy, high transparency, high reaction speed and long life. The capacitive touch screens can further be classified into two types: self capacitance and mutual capacitance. The self capacitive touch screens cannot sense a multi-touch accurately, and are usually applied in electronic products with only single-touch sensing functions or devices with smaller display areas. In comparison, the mutual capacitive touch screens are capable of performing multi-touch sensing functions and other complex touch sensing functions for larger display areas. The cost and complexity of single-layer mutual capacitive touch screens are lower than those of conventional mutual capacitive touch screens with a multi-layer structure.

The mutual capacitive touch screen determines whether there is a touch via capacitive variations between driving areas and receiving areas of touch sensing electrodes. In some conditions, the mutual capacitive signals in the touch sensing electrodes are weak and will not easily be detected, which may cause an error in touch detection. In comparison, the self capacitive touch screen may not possess this kind of error. As both the mutual capacitive touch sensing method and the self capacitive touch sensing method have their individual pros and cons, they cannot be adapted to various touch profiles when used alone. Thus, there is a need to provide a touch sensing method which includes the benefits of both the self capacitive touch sensing method and the mutual capacitive touch sensing method, in order to compensate for the defects of the other.

### SUMMARY OF THE INVENTION

It is therefore an objective of the present invention to provide a touch sensing method possessing the benefits of both the self capacitive touch sensing method and mutual capacitive touch sensing method, which can compensate for the defects of the other.

The present invention discloses a driving and sensing method for a single-layer mutual capacitive multi-touch screen wherein a plurality of touch sensing electrodes are disposed in the single-layer mutual capacitive multi-touch screen and each of the plurality of touch sensing electrodes comprises at least one driving area and at least one receiving area, wherein all driving areas and receiving areas are located in a same layer of the single-layer mutual capacitive multi-touch screen. The driving and sensing method comprises inputting a first driving signal to a plurality of driving areas of the plurality of touch sensing electrodes along a first direction, and receiving a first sensing signal corresponding to the first driving signal from a plurality of receiving areas of the plurality of touch sensing electrodes along the first direction; and inputting a second driving signal to the plurality of driving areas of the plurality of touch sensing electrodes along a second direction, and receiving a second sensing signal corresponding to the second driving signal from the plurality of receiving areas of the plurality of touch sensing electrodes along the second direction; wherein the second direction is substantially perpendicular to the first direction.

The present invention further discloses a driving and sensing method for a single-layer mutual capacitive multi-touch screen wherein a plurality of touch sensing electrodes are disposed in the single-layer mutual capacitive multi-touch screen and each of the plurality of touch sensing electrodes comprises at least one driving area and at least one receiving area, wherein all driving areas and receiving areas are located in a same layer of the single-layer mutual capacitive multi-touch screen. The driving and sensing method comprises inputting a first driving signal to a plurality of driving areas of the plurality of touch sensing electrodes along a first direction, and receiving a first sensing signal corresponding to the first driving signal from a plurality of receiving areas of the plurality of touch sensing electrodes along a second direction, wherein the second direction is substantially perpendicular to the first direction; and in a specific condition, further inputting a second driving signal to the plurality of driving areas of the plurality of touch sensing electrodes along the first direction and receiving a second sensing signal corresponding to the second driving signal from the plurality of receiving areas of the plurality of touch sensing electrodes along the first direction, and inputting a third driving signal to the plurality of driving areas of the plurality of touch sensing electrodes along the second direction and receiving a third sensing signal corresponding to the third driving signal from the plurality of receiving areas of the plurality of touch sensing electrodes along the second direction.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the structure of a single-layer mutual capacitive multi-touch screen according to an embodiment of the present invention.

FIG. 2 is a schematic diagram of a driving and sensing method for the single-layer mutual capacitive multi-touch screen.

FIG. 3 is a schematic diagram of another driving and sensing method for the single-layer mutual capacitive multi-touch screen.

FIG. 4 is a schematic diagram of a driving and sensing process according to an embodiment of the present invention.

FIG. 5 is a schematic diagram of another driving and sensing process according to an embodiment of the present invention.

FIG. 6 is a schematic diagram of a plurality of touch points detected by the driving and sensing method shown in FIG. 3 according to an embodiment of the present invention.

### DETAILED DESCRIPTION

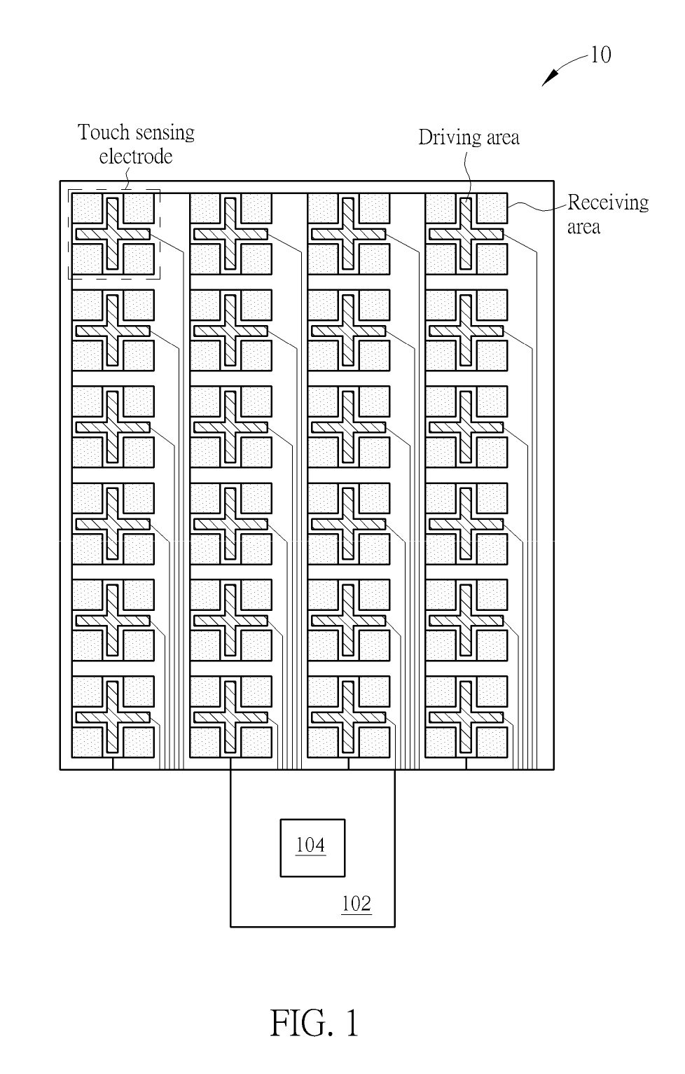

Please refer to FIG. 1, which is a schematic diagram of the structure of a single-layer mutual capacitive multi-touch screen 10 according to an embodiment of the present invention. As shown in FIG. 1, the single-layer mutual capacitive multi-touch screen 10 includes a substrate 100, a flexible printed circuit board (FPC) 102 and a control circuit 104. In the single-layer mutual capacitive multi-touch screen 10, each touch sensing electrode, which is composed of driving areas and receiving areas, is disposed on the substrate 100. For example, in the touch sensing electrodes shown in FIG. 1, the oblique line areas may be the driving areas, and the point areas may be the receiving areas. In other embodiments, the shape or range of the driving areas and receiving areas may be properly adjusted according to different applications, which is not limited herein. The FPC 102 is disposed at a side of the substrate 100. The control circuit 104, located on the FPC 102, is utilized for controlling operations of the touch sensing electrodes on the substrate 100. As shown in FIG. 1, the touch sensing electrodes on the substrate 100 are connected to the FPC 102 below the substrate 100, in order to receive the driving signals of the control circuit 104, and transmit the sensing signals to the control circuit 104.

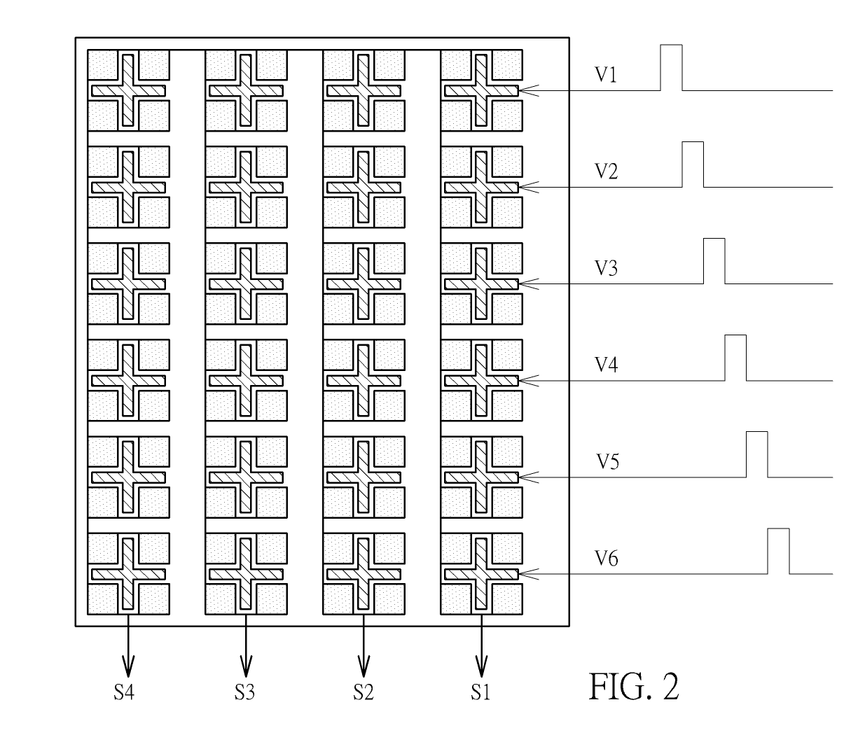

Please refer to FIG. 2, which illustrates a driving and sensing method for the single-layer mutual capacitive multi-touch screen 10. As shown in FIG. 2, the touch sensing electrodes are arranged in a 6×4 array. The driving and sensing method inputs driving signals V1-V6 to each row of the touch sensing electrodes horizontally, and receives sensing signals S1-S4 corresponding to the driving signals V1-V6 vertically. The driving signals V1-V6 are transmitted to the driving areas of the touch sensing electrodes. When a touch occurs, the capacitance between the driving area and receiving area at the touch location may vary. The control circuit 104 may receive the sensing signals S1-S4 from the receiving areas, and determine whether there is a touch according to the sensing signals S1-S4. The control circuit 104 may input the driving signals to the driving areas in each row of the touch sensing electrodes in an order of V1, V2, V3, V4, V5 and V6, and then receive the sensing signals S1-S4 for each of the driving signals V1-V6. The control circuit 104 thereby obtains complete capacitive variations of the single-layer mutual capacitive multi-touch screen 10, in order to calculate the touch location. In some embodiments, the control circuit may also input the driving signals vertically to each column of the touch sensing electrodes, and then receive the sensing signals corresponding to these driving signals horizontally, which may also obtain complete capacitive variations of the single-layer mutual capacitive multi-touch screen 10. In other embodiments, the locations of the driving areas and receiving areas may be interchanged; the driving signals V1-V6 are transmitted to the receiving areas, and the sensing signals S1-S4 are received from the driving areas, which may also achieve the touch sensing effects.

Under some conditions, the touch sensing signals for the method shown in FIG. 2 are weak, which may lead to an error in touch detection of the control circuit 104. For example, when a liquid drops onto the touch screen, the capacitance between the driving areas and receiving areas may vary, and these variations are similar to the capacitive variations generated by a finger touch. The above driving and sensing method may not be able to determine that such capacitive variations come from the presence of a liquid or from a finger touch, which may cause an error. If a touch screen is utilized in a mobile device such as a mobile phone or tablet, the user may put the mobile device on a table and use a single hand to contact the touch screen of the mobile device to perform operations. At this moment, the mobile device has no common grounds with the user, and therefore a loop cannot be formed between the user and the mobile device; the mobile device is electrically floating. In such a situation, the touch sensing signal is weak, which leads to poor touch sensitivity.

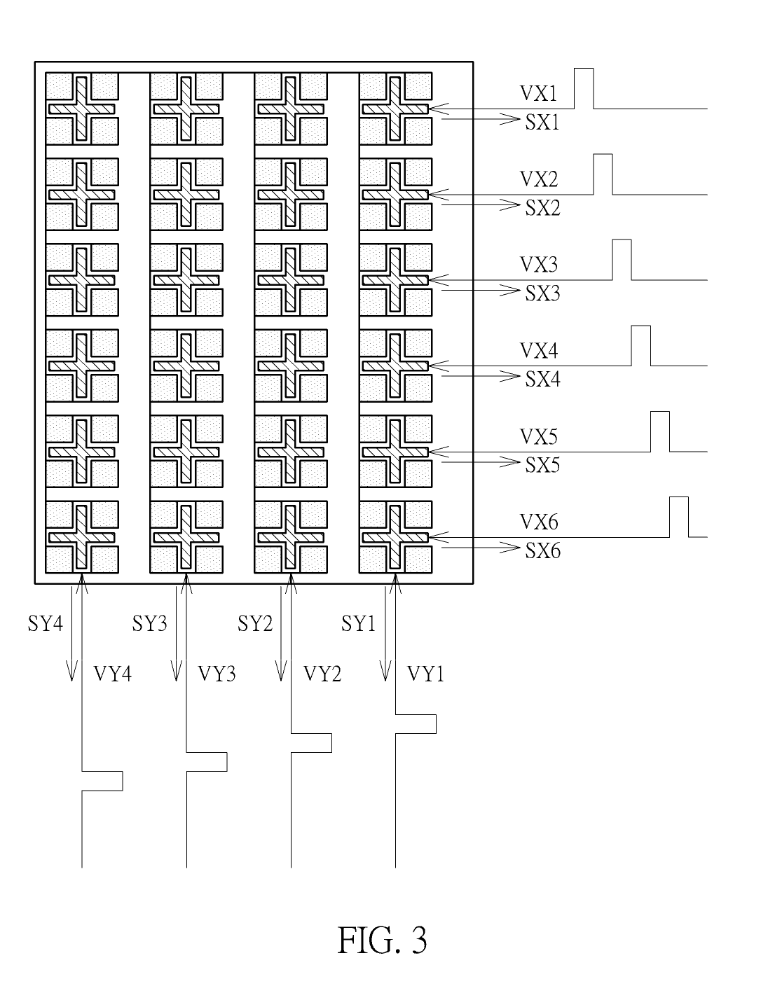

In order to prevent an error from being generated in the touch signal while further increasing the touch sensitivity, an embodiment of the present invention provides another driving and sensing method, as shown in FIG. 3. The control circuit 104 inputs driving signals VX1-VX6 horizontally to each row of the touch sensing electrodes, and receives sensing signals SX1-SX6 corresponding to the driving signals VX1-VX6 horizontally. The control circuit 104 further inputs driving signals VY1-VY4 vertically to each column of the touch sensing electrodes, and receives sensing signals SY1-SY4 corresponding to the driving signals VY1-VY4 vertically. Such a driving and sensing method may achieve better touch sensing performance.

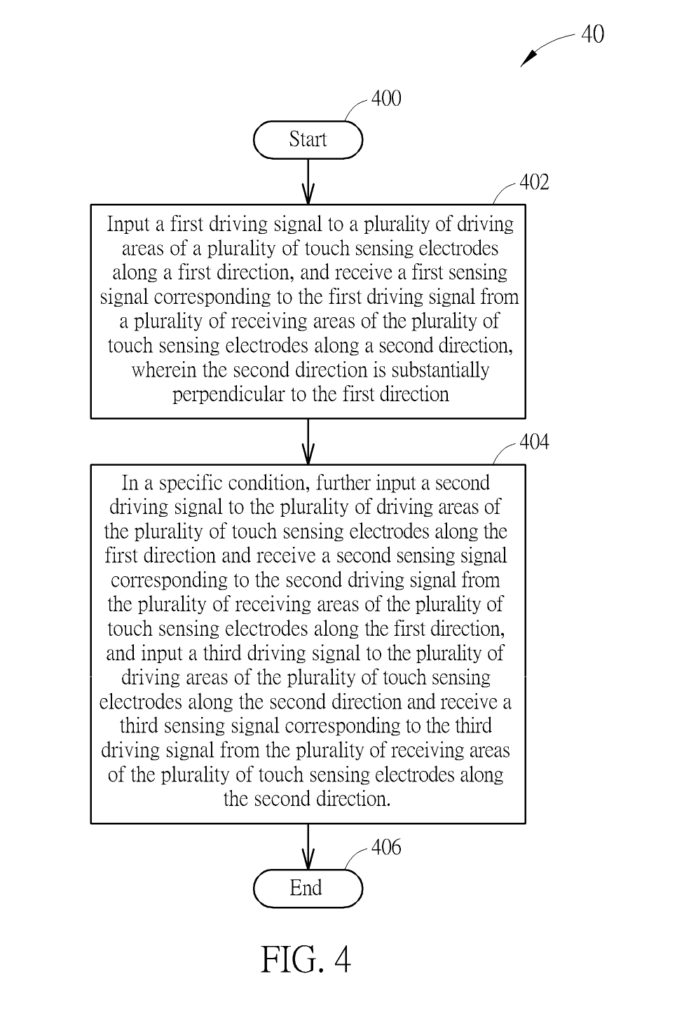

Please note that the driving and sensing method shown in FIG. 3 may determine whether a signal comes from a drop of liquid or from a finger touch on the touch screen. When the mobile device is electrically floating, the sensing method shown in FIG. 3 may also achieve better touch sensing results. As a result, when the single-layer mutual capacitive multi-touch screen 10 cannot successfully determine whether there is a touch after using the driving and sensing method shown in FIG. 2, it may further use the driving and sensing method shown in FIG. 3. The related operations can be summarized into a driving and sensing process 40, as shown in FIG. 4. The driving and sensing process 40 includes the following steps:

Step 400: Start.

Step 402: Input a first driving signal to a plurality of driving areas of a plurality of touch sensing electrodes along a first direction, and receive a first sensing signal corresponding to the first driving signal from a plurality of receiving areas of the plurality of touch sensing electrodes along a second direction, wherein the second direction is substantially perpendicular to the first direction.

Step 404: In a specific condition, further input a second driving signal to the plurality of driving areas of the plurality of touch sensing electrodes along the first direction and receive a second sensing signal corresponding to the second driving signal from the plurality of receiving areas of the plurality of touch sensing electrodes along the first direction, and input a third driving signal to the plurality of driving areas of the plurality of touch sensing electrodes along the second direction and receive a third sensing signal corresponding to the third driving signal from the plurality of receiving areas of the plurality of touch sensing electrodes along the second direction.

Step 406: End.

The specific condition in the driving and sensing process 40 may be the abovementioned condition where a liquid is dropped onto the screen or the mobile device is electrically floating. It may also be another condition which causes the driving and sensing method shown in FIG. 2 to be unable to successfully determine whether there is a touch; this is not limited herein. When the driving and sensing method shown in FIG. 2 is used and a touch object cannot be determined successfully, the driving and sensing method shown in FIG. 3 may further be used, in order to compensate for the defects of the driving and sensing method shown in FIG. 2 and thereby achieve better touch sensing performance.

In some embodiments, the driving and sensing method shown in FIG. 3 may also be performed directly without first undergoing the driving and sensing method shown in FIG. 2. In this case, in the driving and sensing process 40, Step 402 is omitted and the driving and sensing method narrated in Step 404 is performed directly. In such a situation, the abovementioned determination error may not occur when a liquid drops onto the screen or the mobile device is electrically floating. The driving and sensing method shown in FIG. 3, however, cannot accurately determine multi-touch locations. Thus, another implementation may be performed, where the driving and sensing method shown in FIG. 3 is first used to obtain a sensing result, and when the sensing result indicates that there is a plurality of touch points, the driving and sensing method shown in FIG. 2 is then used to find out the locations of the plurality of touch points. When the sensing result indicates that there is only a single touch point, the driving and sensing method shown in FIG. 2 will not be used. The control circuit 104 may directly output the location of the single touch point for follow-up signal processing.

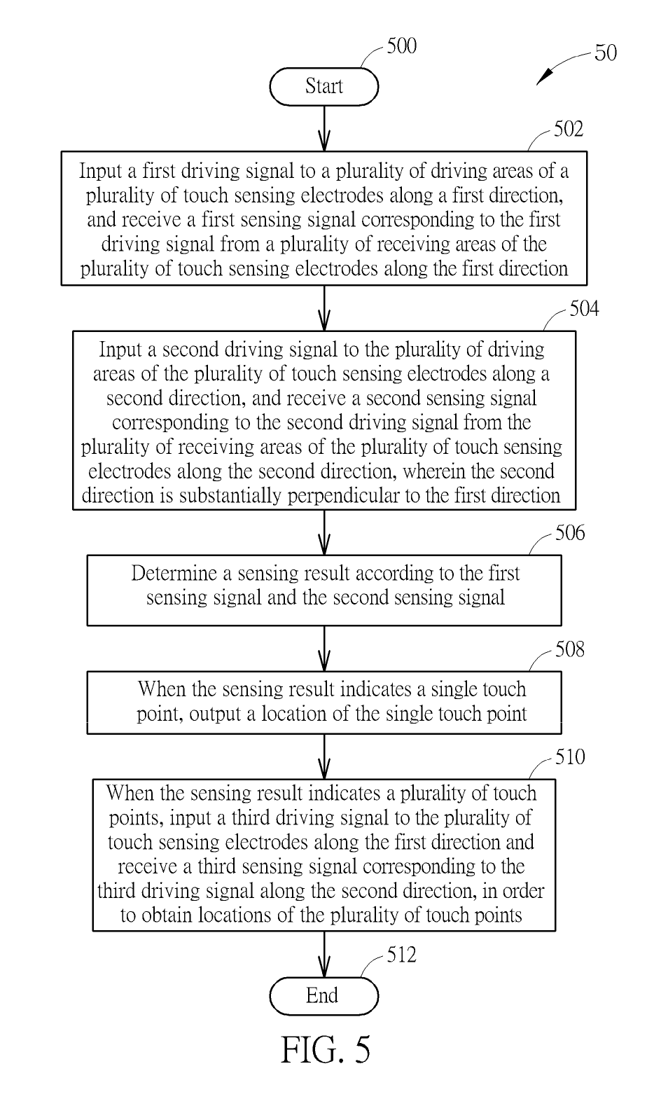

The above steps of first obtaining the sensing results related to touch points via the driving and sensing method shown in FIG. 3 and ensuring the locations of the plurality of touch points via the driving and sensing method shown in FIG. 2 can be summarized into a driving and sensing process 50, as shown in FIG. 5. The driving and sensing process 50 includes the following steps:

Step 500: Start.

Step 502: Input a first driving signal to a plurality of driving areas of a plurality of touch sensing electrodes along a first direction, and receive a first sensing signal corresponding to the first driving signal from a plurality of receiving areas of the plurality of touch sensing electrodes along the first direction.

Step 504: Input a second driving signal to the plurality of driving areas of the plurality of touch sensing electrodes along a second direction, and receive a second sensing signal corresponding to the second driving signal from the plurality of receiving areas of the plurality of touch sensing electrodes along the second direction, wherein the second direction is substantially perpendicular to the first direction.

Step 506: Determine a sensing result according to the first sensing signal and the second sensing signal.

Step 508: When the sensing result indicates a single touch point, output a location of the single touch point.

Step 510: When the sensing result indicates a plurality of touch points, input a third driving signal to the plurality of touch sensing electrodes along the first direction and receive a third sensing signal corresponding to the third driving signal along the second direction, in order to obtain locations of the plurality of touch points.

Step 512: End.

In the driving and sensing process 50, the driving and sensing method shown in FIG. 3 cannot deal with the multi-touch condition, and thus the driving and sensing method shown in FIG. 2 is required only when the sensing result indicates that there is a plurality of touch points. As a result, the driving and sensing method shown in FIG. 2 can compensate for the fact that the driving and sensing method shown in FIG. 3 cannot deal with multi-touch, and this achieves a better overall touch sensing effects.

Please note that, according to the embodiments of the present invention, as long as the driving and sensing method shown in FIG. 3 is performed in the single-layer mutual capacitive multi-touch screen, various methods should be included in the scope of the present invention no matter whether the driving and sensing method shown in FIG. 3 is used together with the driving and sensing method shown in FIG. 2 or with another driving and sensing method. Those skilled in the art can make various modifications and alterations according to system requirements. For example, in the above embodiment where the driving and sensing method shown in FIG. 2 is used to assist the driving and sensing method shown in FIG. 3 to deal with the multi-touch condition, the driving and sensing method shown in FIG. 2 may undergo the complete touch screen or may only be performed at possible locations of the touch points.

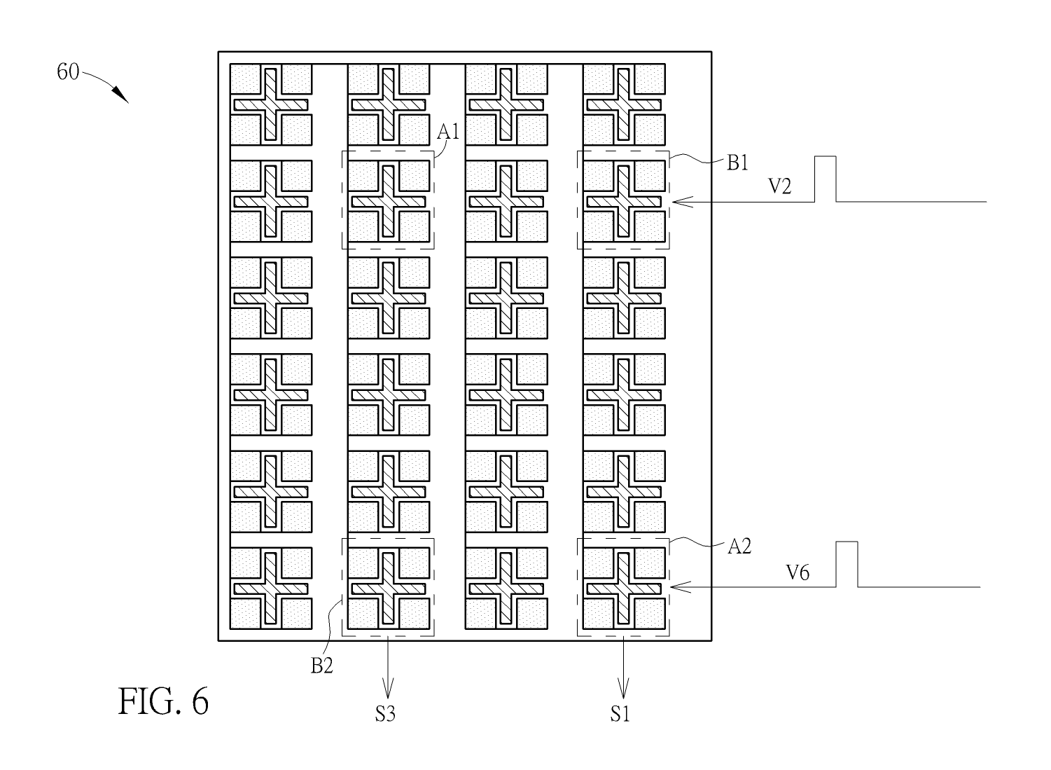

Please refer to FIG. 6, which is a schematic diagram of a plurality of touch points detected by the driving and sensing method shown in FIG. 3 according to an embodiment of the present invention. As shown in FIG. 6, after the driving and sensing method shown in FIG. 3 is performed in a single-layer mutual capacitive multi-touch screen 60, locations A1, A2, B1 and B2 are determined to be possible touch points; hence the touch pattern will be multi-touch. When the driving and sensing method shown in FIG. 3 is applied, a touch occurring in the locations A1 and A2 or a touch occurring in the locations B1 and B2 may both lead to the above sensing result; hence, the driving and sensing method shown in FIG. 2 has to be used to find out the actual locations of touch points. In an embodiment, the driving and sensing method shown in FIG. 2 maybe performed in order to obtain the actual touch locations among the locations A1, A2, B1 and B2. In FIG. 6, the driving and sensing method shown in FIG. 2 is only performed in possible locations of multi-touch points; that is, the control circuit only inputs the driving signals V2 and V6 horizontally to the 2^{nd} and the 6^{th} rows of the touch sensing electrodes, respectively, and receives the corresponding sensing signals S1 and S3 vertically. As a result, the actual touch locations may be determined according to the sensing signals S1 and S3. In an embodiment, in order to find out more accurate touch locations by calculation, the driving and sensing method shown in FIG. 2 may be performed in touch sensing electrodes having a distance within a specific range to possible locations of the touch points. For example, for the possible locations of touch points located in the 2^{nd} row (i.e. A1 and B1), the control circuit may input the driving signals V1, V2 and V3 horizontally to the 1^{st}, the 2^{nd} and the 3^{rd} rows of the touch sensing electrodes, respectively, and receive the corresponding sensing signals S1-S4 vertically. The control circuit may further calculate the sensed capacitance values to obtain more accurate locations of touch inputs. Similarly, for the possible locations of touch points located in the 6^{th} row (i.e. A2 and B2), the control circuit may input the driving signals V5 and V6 horizontally to the 5^{th} and the 6^{th} rows of the touch sensing electrodes, respectively, and receive the corresponding sensing signals S1-S4 vertically. The control circuit may further calculate the sensed capacitance values to obtain more accurate locations of touch points.

In the prior art, the self capacitive touch screens cannot deal with multi-touch; and the mutual capacitive signals of the touch sensing electrodes in the mutual capacitive touch screens are weak and not easily detected in some conditions, which may cause an error of touch detection. The mutual capacitive touch sensing method and the self capacitive touch sensing method have their respective pros and cons. Both touch sensing methods cannot be adapted to various touch profiles when used alone. In comparison, the present invention provides a touch sensing method, which comprises the benefits of both the self capacitive touch sensing method and the mutual capacitive touch sensing method and compensates for the defects of both the self capacitive touch sensing method and the mutual capacitive touch sensing method, in order to achieve better touch sensing performance.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving and sensing method for a single-layer mutual capacitive multi-touch screen wherein a plurality of touch sensing electrodes are disposed in the single-layer mutual capacitive multi-touch screen and each of the plurality of touch sensing electrodes comprises at least one driving area and at least one receiving area, wherein all driving areas and receiving areas are located in a same layer of the single-layer mutual capacitive multi-touch screen, the driving and sensing method comprising:
inputting a first driving signal to a plurality of driving areas of the plurality of touch sensing electrodes along a first direction, and receiving a first sensing signal corresponding to the first driving signal from a plurality of receiving areas of the plurality of touch sensing electrodes along the first direction; and
inputting a second driving signal to the plurality of driving areas of the plurality of touch sensing electrodes along a second direction, and receiving a second sensing signal corresponding to the second driving signal from the plurality of receiving areas of the plurality of touch sensing electrodes along the second direction;
wherein the second direction is substantially perpendicular to the first direction.

2. The driving and sensing method of claim 1, further comprising determining a sensing result according to the first sensing signal and the second sensing signal.

3. The driving and sensing method of claim 2, wherein when the sensing result indicates a single touch point, the method further comprises outputting a location of the single touch point.

4. The driving and sensing method of claim 2, wherein when the sensing result indicates a plurality of touch points, the method further comprises inputting a third driving signal to the plurality of touch sensing electrodes along the first direction and receiving a third sensing signal corresponding to the third driving signal along the second direction, in order to obtain locations of the plurality of touch points.

5. The driving and sensing method of claim 2, wherein when the sensing result indicates a plurality of touch points, the method further comprises inputting a fourth driving signal to specific touch sensing electrodes among the plurality of touch sensing electrodes along the first direction, wherein the specific touch sensing electrodes have a distance within a specific range to possible locations of the plurality of touch points, and receiving a fourth sensing signal corresponding to the fourth driving signal along the second direction, in order to obtain locations of the plurality of touch points.

6. A driving and sensing method for a single-layer mutual capacitive multi-touch screen wherein a plurality of touch sensing electrodes are disposed in the single-layer mutual capacitive multi-touch screen and each of the plurality of touch sensing electrodes comprises at least one driving area and at least one receiving area, wherein all driving areas and receiving areas are located in a same layer of the single-layer mutual capacitive multi-touch screen, the driving and sensing method comprising:
inputting a first driving signal to a plurality of driving areas of the plurality of touch sensing electrodes along a first direction, and receiving a first sensing signal corresponding to the first driving signal from a plurality of receiving areas of the plurality of touch sensing electrodes along a second direction, wherein the second direction is substantially perpendicular to the first direction; and
in a specific condition, further inputting a second driving signal to the plurality of driving areas of the plurality of touch sensing electrodes along the first direction and receiving a second sensing signal corresponding to the second driving signal from the plurality of receiving areas of the plurality of touch sensing electrodes along the first direction, and inputting a third driving signal to the plurality of driving areas of the plurality of touch sensing electrodes along the second direction and receiving a third sensing signal corresponding to the third driving signal from the plurality of receiving areas of the plurality of touch sensing electrodes along the second direction.

7. The driving and sensing method of claim 6, wherein the specific condition comprises a liquid dropping onto the single-layer mutual capacitive multi-touch screen.

8. The driving and sensing method of claim 6, wherein the specific condition comprises that the single-layer mutual capacitive multi-touch screen is electrically floating.
